(19) United States
(12) Patent Application Publication
(10) Pub. No.: US 2010/0247019 A1
(43) Pub. Date: Sep. 30, 2010

(54) WHEEL BEARING ARRANGEMENT FOR MOTOR VEHICLES

(76) Inventors: Horst Döppling, Herzogenaurach (DE); Heinrich Hofmann, Schweinfurt (DE); Rainer Eidloth, Herzogenaurach (DE); Robert Plank, Weisendorf (DE); Ludwig Winkelmann, Erlangen (DE)

Correspondence Address: Charles Muserlain, 317 Bliss Lane, Valley Cottage, NY, 10989, US

(21) Appl. No.: 12/312,277

(22) PCT Filed: Oct. 15, 2007
(86) PCT No.: PCT/EP2007/060952

§ 371 Date: May 21, 2010

(30) Foreign Application Priority Data
Nov. 2, 2006 (DE) 10 2006 051 644.3

(51) Int. Cl. F16C 13/02

(52) U.S. Cl. 384/589

(57) ABSTRACT

A wheel mounting for automotive vehicles substantially comprising a multi-row angular contact rolling bearing comprising an inner bearing ring arranged on or at least partially integrated in a hub of a wheel side-fixing flange, an outer bearing ring coaxial to the inner bearing ring and arranged in or at least partially integrated in a hub of a vehicle side-fixing flange, and a plurality of rolling elements arranged in a plurality of rows next to one another between the inner and the outer bearing rings, which rolling elements roll on defined, inclined pressure angle axes in groove-shaped raceways of the inner and the outer bearing rings and are retained uniformly spaced from one another in peripheral direction in a plurality of bearing cages wherein all the rolling elements of the angular contact rolling bearing are configured in form of ball-rollers comprising two parallel side surfaces obtained by symmetric flattening of a basic ball shape such that a width of the ball-rollers between these side surfaces is 20% to 30% smaller than a diameter of the basic ball shape.

### FIELD OF THE INVENTION

The invention concerns a wheel mounting for automotive vehicles substantially comprising a multi-row angular contact rolling bearing comprising an inner bearing ring arranged on or at least partially integrated in a hub of a wheel side-fixing flange, an outer bearing ring coaxial to the inner bearing ring and arranged in or at least partially integrated in a hub of a vehicle side-fixing flange, and a plurality of rolling elements arranged in a plurality of rows next to one another between the inner and the outer bearing rings, which rolling elements roll on defined, inclined pressure angle axes in groove-shaped raceways of the inner and the outer bearing rings and are retained uniformly spaced from one another in peripheral direction in a plurality of bearing cages. The invention can be particularly advantageously used with driven and non-driven wheels and steerable and non-steerable wheels.

### BACKGROUND OF THE INVENTION

Wheel bearings are highly loaded parts that, at all events, have to withstand the most different operational loads occurring during driving operation. In the case of automotive vehicles, a difference is made between driven and non-driven wheels that, again, are divided into steerable and non-steerable wheels. What applies basically to all wheels is that, to ensure safe driving, the wheels have to be guided as exactly and with as little lash as possible and therefore need a rigid mounting with a high bearing capacity. In the case of passenger vehicles, this is achieved in the first place by using double-row angular contact ball bearings in a back-to-back arrangement, while in utility vehicles, due to the higher load ratings, above all, two single-row taper roller bearings in back-to-back arrangement or even double-row taper roller bearings are used. However, to increase the bearing capacity and the tilting rigidity of the wheel mounting, it is also known to mount driven and non-driven wheels of passenger vehicles on multi-row angular contact rolling bearings of the type known, for example, from the generic document DE 103 31 936 A1. Such a wheel mounting is substantially constituted by a four-row angular contact ball bearing that comprises a two-part inner bearing ring mounted on a hub of a wheel side-fixing flange, a one-piece outer bearing ring coaxial to the inner bearing ring and mounted in a hub of a vehicle side-fixing flange or integrated in this, and a plurality of bearing balls arranged next to one another in four rows between these bearing rings, the pitch circle diameter of the two axially inner rows being smaller than the pitch circle diameter of the two axially outer rows. The bearing balls roll on defined, inclined pressure angle axes in groove-shaped raceways in the two bearing rings and are retained uniformly spaced from one another in peripheral direction by two bearing cages each of which receives one inner and one outer row of the bearing balls.

However, a drawback of these wheel mountings formed by four-row angular contact ball bearings has proved to be that they also very soon reach the limits of their efficiency as far as bearing capacity and rigidity of the bearing are concerned, so that, in many cases of use, they do not provide the desired enhancement of durability. This is due to the fact that, although in most wheel mountings sufficient radial design space is available for using bearing balls with larger diameters with the aim of increasing the bearing capacity and rigidity of such an angular contact ball bearing, in the majority of cases, however, the possibility of enlarging the axial design space for the angular contact ball bearing required at the same time remains limited due to the surrounding structure of the wheel mounting. Despite the fact that the available design space remains substantially unchanged, automobile manufacturers are making ever-increasing demands on the wheel bearings with regard to bearing capacity, rigidity and durability.

### OBJECTS OF THE INVENTION

In view of the aforesaid drawbacks of the prior art, it is an object of the invention to provide a compact wheel mounting for automotive vehicles comprising a multi-row angular contact rolling bearing which, without necessitating modifications to the surrounding structure, possesses a substantially higher bearing capacity and rigidity and thus, also, a longer durability.

This and other objects and advantages of the invention will become obvious from the following detailed description.

### DESCRIPTION OF THE INVENTION

The invention achieves its objects by the fact that all the rolling elements of the angular contact rolling bearing are configured in form of ball-rollers comprising two parallel side surfaces obtained by symmetric flattening of a basic ball shape such that a width of the ball-rollers between these side surfaces is 20% to 30% smaller than a diameter of the basic ball shape.

The invention is therefore based on the insight that by using ball-rollers as rolling elements for the multi-row angular contact rolling bearing of the wheel mounting, it is possible to use rolling elements having a much larger diameter than conventional bearing balls, so that the bearing capacity and the rigidity of the angular contact rolling bearing are substantially enhanced and, due to the laterally flattened and thus narrow configuration of the rolling elements, no additional axial design space is required for such an angular contact rolling bearing.

According to a further proposition of the invention, the angular contact rolling bearing of the wheel mounting of the invention preferably comprises four rows of rolling elements configured as ball-rollers, and a preferably identical pitch circle diameter of the two axially inner rows is smaller than a likewise preferably identical pitch circle diameter of the two axially outer rows. In addition, the diameter of the basic ball shape of the rolling elements of the two axially outer rows is larger than the diameter of the rolling elements of the two axially inner rows, so that a first and a second pair of rows comprising different rolling element diameters and different pitch circle diameters are formed by the axially outer rows together with the respective, adjoining axially inner rows. But it would also be possible to configure the axially inner and the axially outer rolling element rows with different pitch circle diameters and configure the ball-rollers of all the rows with the same diameter of the basic ball shape. It is further conceivable to configure the ball-rollers on the spherical portions of their running surfaces additionally with a logarithmically diminishing run-out profile and thus counteract the edge stresses occurring between the ball rollers and their raceways in the bearing rings.

According to further propositions of the invention, the pressure angle axes of each pair of rows of rolling elements either diverge or converge or extend parallel to each other in direction of the central longitudinal axis of the angular contact rolling bearing, and the two pairs of rows of rolling elements are positioned axially mirror-inverted to each other i.e. in back-to-back arrangement. In case of arrangement of the two pairs of rows on diverging or converging pressure angle axes, it has proved to be advantageous to guide each row of rolling elements in a separate bearing cage, preferably in a bearing cage configured as a plastic window-type cage, whereas, if the two pairs of rows are arranged on parallel pressure angle axes, each pair of rows can be guided in a common bearing cage that is also preferably configured as a plastic window-type cage.

Arranging the rolling elements of the two pairs of rows on pressure angle axes diverging in direction of the central longitudinal axis of the angular contact rolling bearing has the additional advantage that, through the large supporting width of the two axially outer rows of rolling elements, the angular contact rolling bearing has a high tilting rigidity accompanied by a high radial bearing ratio due to the relatively small supporting width of the two axially inner rows of rolling elements. In contrast, an arrangement of the rolling elements of both pairs of rows on pressure angle axes converging in direction of the central longitudinal axis of the angular contact rolling bearing has the advantage that the tilting rigidity of the angular contact rolling bearing can be particularly strongly enhanced, while the radial bearing capacity of the angular contact rolling bearing is then somewhat lower.

However, an arrangement of the rolling elements of the two pairs of rows along pressure angle axes extending parallel to each other in direction of the central longitudinal axis of the angular contact rolling bearing has proved to be particularly advantageous because this arrangement assures that individual ball-roller pairs in the two pairs of rows do not have different speeds of rotation and thus roll synchronously, and are supported on each other due to the fact that their side surfaces bear against each other. This enables a high packaging compactness because the ball rollers can be arranged extremely closely to each other in the angular contact rolling bearing, so that a mounting with a high bearing capacity and an extremely low-friction is achieved, and, on the other hand, both pairs of rows can be guided in a respective common bearing cage which results in the availability of an additional volume defined by the empty space between the bearing rings for the grease depot of the angular contact rolling bearing.

In an advantageous development of the wheel mounting of the invention, the outer bearing ring of the angular contact rolling bearing of the invention is entirely integrated in the hub of the vehicle side-fixing flange by the fact that the outer raceways of the individual rows of rolling elements are configured directly in the inner side of the hub of the vehicle side-fixing flange. In itself, this type of configuration is known from conventional wheel bearings of the 2^{nd} and 3^{rd} level of integration and has also proved to be the most advantageous for the wheel mounting of the invention from the point of view of manufacturing techniques and with regard to low costs of manufacture. However, it is equally possible to use wheel bearings of the 1^{st} level of integration that comprise a separate outer bearing ring arranged in the hub of a vehicle side-fixing flange and to configure these bearings according to the invention with rolling elements in the form of ball-rollers.

According to another proposition of the invention, it has likewise proved to be advantageous to configure the inner bearing ring comprising the inner raceways of the individual rows of rolling elements of the angular contact rolling bearing of the invention out of two separate solid fractional rings out of a rolling bearing steel as known from conventional wheel bearings of the 1^{st} and the 2^{nd} level of integration. An inner bearing ring with such a configuration possesses a high stability of shape and wear resistance and has proved itself in practice. A particularly economic alternative is obtained through a proposed variant of the first form of embodiment in which the inner bearing ring is made of two separate cold-formed fractional rings out of a deep-drawing rolling bearing steel. The most suitable material for this is 100Cr6mod or C80M, so that even an inner bearing ring made by this method meets the necessary requirements of shape stability and wear resistance. Independently of their method of production, these fractional rings of the inner bearing ring are positionally fixed on one side on a shoulder of the hub of the wheel side-fixing flange and are clamped against each other on the other side by a bent-over rim on this hub.

According to a second alternative form of embodiment of the wheel mounting of the invention, finally, the inner bearing ring of the angular contact rolling bearing comprises a separate fractional ring on one side comprising the inner raceways of one pair of rows of rolling elements and the inner bearing ring is integrated on the other side in the hub of the wheel side-fixing flange by the fact that the inner raceways of the other pair of rows of rolling elements are configured directly in the outer side of the hub. The separate fractional ring of the inner bearing ring can likewise be made optionally out of a deep-drawing steel or a rolling bearing steel and be positionally fixed on one side on the hub of the wheel side-fixing flange against a shoulder arranged adjacent the inner raceways of the other pair of rows that are configured in the hub, and be clamped on the other side against the shoulder by a bent-over rim on this hub.

To sum up, the wheel mounting of the invention thus has the advantage over wheel mountings of the prior art that through the use of ball-rollers as rolling elements, the wheel bearing configured as a multi-row angular contact rolling bearing has a much higher bearing capacity and rigidity and thus also an enhanced durability without modifications to the surrounding structure.

### BRIEF DESCRIPTION OF THE DRAWINGS

The invention will now be described more closely with reference to the appended drawings and several preferred examples of embodiment.

FIG. 1 shows a cross-section through a first example of embodiment of a wheel mounting of the invention;

FIG. 2 shows a cross-section through a variant of the first example of embodiment of the wheel mounting of the invention;

FIG. 3 shows a cross-section through a second example of embodiment of a wheel mounting of the invention;

FIG. 4 shows a cross-section through a third example of embodiment of a wheel mounting of the invention.

### DETAILED DESCRIPTION OF THE INVENTION

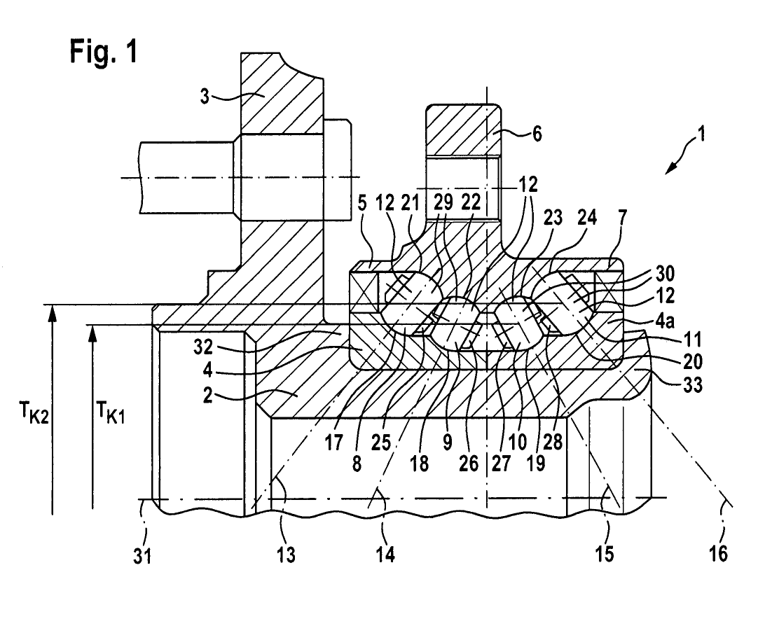

FIGS. 1 to 4 clearly show four different embodiments of an automotive vehicle wheel mounting substantially comprising a four-row angular contact rolling bearing 1 comprising an inner bearing ring 4, 4a arranged on or at least partially integrated in a hub 2 of a wheel side-fixing flange 3 and an outer bearing ring 7 coaxial to the inner bearing ring and integrated in a hub 5 of a vehicle side-fixing flange 6, and further comprising a plurality of rolling elements 12 arranged next to one another in four rows 8, 9, 10, 11 between the bearing rings 4, 4a, 5. It can likewise be seen from the drawings that the rolling elements 12 of the angular contact rolling bearing 1 roll on inclined pressure angle axes 13, 14, 15, 16 in groove-shaped raceways 17, 18, 19, 20 and 21, 22, 23 24 in the bearing rings 4, 4a, 5 while being retained uniformly spaced from one another in peripheral direction through a plurality of bearing cages 25, 26, 27, 28.

Further, it is also to be seen clearly in all the figures that all the rolling elements 12 of the individual rows 8, 9, 10, 11 of the angular contact rolling bearing 1 of the invention are configured as ball-rollers that comprise two parallel side surfaces that are symmetrically flattened from the basic ball shape. The width of the ball-rollers between these side surfaces is reduced compared to the diameter of the basic ball shape by 20% to 30%, so that the rolling elements 12 used for enhancing the bearing capacity and the rigidity of the angular contact rolling bearing 1 having considerably larger diameters than conventional bearing balls do not need additional axial design space.

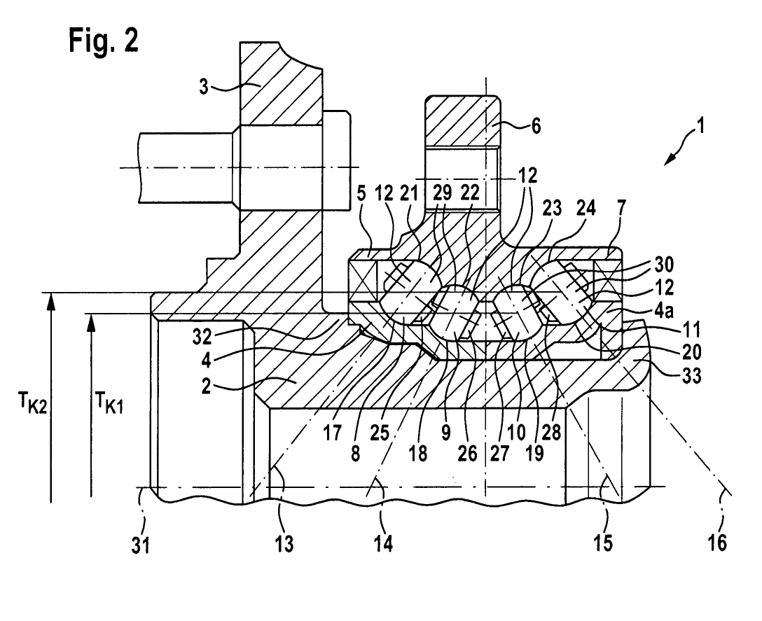

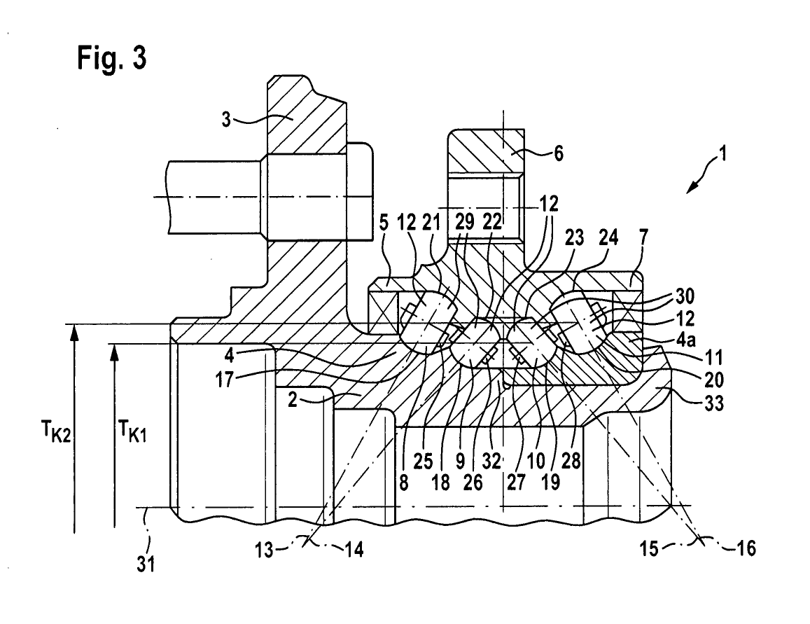

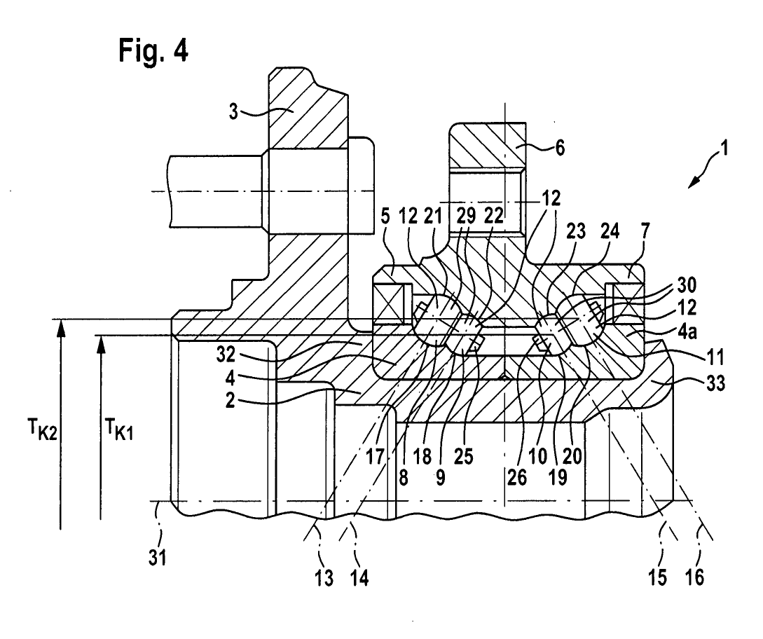

Another common feature of the four examples of embodiment of the wheel mounting of the invention is that the identical pitch circle diameter T_{K1} of the two axially inner rows 9, 10 is smaller than the likewise identical pitch circle diameter T_{K2} of the two axially outer rows 8, 11, and at the same time, the diameter of the basic ball shape of the rolling elements 12 of the two axially outer rows 8, 11 is larger than the diameter of the basic ball shape of the rolling elements 12 of the two axially inner rows 9, 10. The axially outer rows 8, 11 form with the respective, adjoining axially inner rows 9, 10 of rolling elements 12, a first and a second pair of rows 29, 30 in which the pressure angle axes 13, 14, 15, 16 of the rolling elements 12 diverge as shown in FIGS. 1 and 2, or converge as shown in FIG. 3, or extend parallel to each other in the direction of the central longitudinal axis 31 as shown in FIG. 4, and the rows of rolling elements are disposed in a mirror-inverted or back-to-back arrangement to each other. It is further shown in FIGS. 1 to 3 that if the two pairs of rows 29, 30 are arranged on diverging or converging pressure angle axes 13, 14, 15, 16, each of the rows 8, 9, 10, 11 of rolling elements 12 is guided in a separate bearing cage 25, 26, 27, 28 configured as a plastic window-type cage, while in an arrangement of the two pairs of rows on parallel pressure angle axes 13, 14, 15, 16, as in FIG. 4, each pair of rows 29, 30 is guided in a common bearing cage 25, 26, likewise configured as a plastic window-type cage.

A common feature of the present wheel mountings of the invention with regard to the configuration of the outer bearing ring 7 of the angular contact rolling bearing 1 is that this outer bearing ring 7 is entirely integrated in the hub 5 of the vehicle side-fixing flange 6 by the fact that the outer raceways 21, 22, 23, 24 of the individual rows 8, 9, 10, 11 of rolling elements 12 are configured directly in the inner side of the hub 5 of the vehicle side-fixing flange 6. However, one difference between the individual forms of embodiment of the wheel mountings of the invention to be clearly seen in the drawings is that the inner bearing ring 4, 4a of the first form of embodiment of the angular contact rolling bearing 1 shown in FIG. 1 and comprising the inner raceways 17, 18, 19, 20 of the individual rows 8, 9, 10, 11 of rolling elements 12 is made up of two separate solid fractional rings made of a rolling bearing steel, while the inner bearing ring 4, 4a of the variant of the first form of embodiment shown in FIG. 2 is made up of two separate cold-formed fractional rings made of a deep-drawing rolling bearing steel.

In contrast, the second form of embodiment of the angular contact rolling bearing 1 illustrated in FIG. 3 differs from the first form of embodiment by the fact that the inner bearing ring 4, 4a of the angular contact rolling bearing 1 is formed on one side by a separate fractional ring 4a comprising the raceways 19, 20 of the one pair 30 of rows of rolling elements 12 and, on the other side, it is integrated in the hub 2 of the wheel side-fixing flange 3 by the fact that the inner raceways 17, 18 of the other pair 29 of rows of rolling elements 12 are configured directly in the outer side of this hub 2. In the third form of embodiment of the angular contact rolling bearing 1 shown in FIG. 4, in contrast, the configuration of the inner bearing ring 4, 4a is substantially similar to that of the first form of embodiment but differs from the other forms of embodiment by the fact that the two pairs 29, 30 of rows of rolling elements 12 are arranged on respective, parallel pressure angle axes 13, 14, 15, 16.

As can be seen in FIGS. 1 to 4, a final common feature of all four embodiments of the wheel mounting of the invention is that the fractional rings of the inner bearing ring 4, 4a are firmly seated on the hub 2 of the fixing flange 3 and, independently of the method of fabrication, they are fixed with one outer side of one of the fractional rings on a shoulder 32 of the hub 2 of the wheel side-fixing flange 3. On the other side, the hub 2 of the fixing flange 3 comprises a radially outwards bent rim 33 that is pressed against the other outer side of the other fractional ring of the inner bearing ring 4a, so that both fractional rings of the inner bearing ring 4, 4a are clamped against each other.

### LIST OF REFERENCE NUMERALS

1 Angular contact rolling bearing
2 Hub of 3
3 Fixing flange
4 Inner bearing ring
4a Fractional ring of 4
5 Hub of 6
6 Fixing flange
7 Outer bearing ring
8 Rolling element row
9 Rolling element row
10 Rolling element row
11 Rolling element row
12 Rolling element
13 Pressure angle axis
14 Pressure angle axis
15 Pressure angle axis
16 Pressure angle axis
17 Inner raceway
18 Inner raceway
19 Inner raceway
20 Inner raceway
21 Outer raceway
22 Outer raceway
23 Outer raceway
24 Outer raceway
25 Bearing cage
26 Bearing cage
27 Bearing cage
28 Bearing cage
29 Pair of rows
30 Pair of rows
31 Central longitudinal axis
32 Shoulder
33 Bent-over rim
Tₖ₁ Pitch circle diameter of 9, 10
T_{K2} Pitch circle diameter of 8, 11

1. A wheel mounting for automotive vehicles substantially comprising a multi-row angular contact rolling bearing comprising an inner bearing ring arranged on or at least partially integrated in a hub of a wheel side-fixing flange, an outer bearing ring coaxial to the inner bearing ring and arranged in or at least partially integrated in a hub of a vehicle side-fixing flange, and a plurality of rolling elements arranged in a plurality of rows next to one another between the inner and the outer bearing rings, which rolling elements roll on defined, inclined pressure angle axes in groove-shaped raceways of the inner and the outer bearing rings and are retained uniformly spaced from one another in peripheral direction in a plurality of bearing cages wherein all the rolling elements of the angular contact rolling bearing are configured in form of ball-rollers comprising two parallel side surfaces obtained by symmetric flattening of a basic ball shape such that a width of the ball-rollers between these side surfaces is 20% to 30% smaller than a diameter of the basic ball shape.

2. A wheel mounting of claim 1, wherein the angular contact rolling bearing comprises four rows of rolling elements configured as ball-rollers, and a identical pitch circle diameter (Tₖ₁) of two axially inner rows is smaller than a identical pitch circle diameter (Tₖ₂) of two axially outer rows.

3. A wheel mounting of claim 2, wherein a diameter of the basic ball shape of the rolling elements of the two axially outer rows is larger than a diameter of the rolling elements of the two axially inner rows, and the axially outer rows form with a respective, adjacent axially inner row of rolling elements a first and a second pair of rows.

4. A wheel mounting of claim 3, wherein the pressure angle axes of each pair of rows of rolling elements either diverge or converge or extend parallel to each other in direction of a central longitudinal axis of the angular contact rolling bearing, and the two pairs of rows of rolling elements are positioned axially mirror-inverted in a back-to-back arrangement relative to each other.

5. A wheel mounting of claim 4, wherein, when the two pairs of rows are arranged on diverging or converging pressure angle axes, each row of rolling elements is guided in a separate bearing cage whereas, when the two pairs of rows are arranged on parallel pressure angle axes each pair (29, 30) of rows is guided in a common bearing cage.

6. A wheel mounting of claim 1, wherein the outer bearing ring of the angular contact rolling bearing is entirely integrated in the hub of the vehicle side-fixing flange in that the outer raceways of the individual rows of rolling elements are configured directly in the inner side of the hub of the vehicle side-fixing flange.

7. A wheel mounting of claim 6, wherein the inner bearing ring of the angular contact rolling element comprising the inner raceways of the individual rows of rolling elements is made of two separate solid fractional rings that are made out of a rolling bearing steel and are positionally fixed on one side on a shoulder of the hub of the wheel side-fixing flange and clamped against each other on another side by a bent-over rim on said hub.

8. A wheel mounting of claim 6, wherein the inner bearing ring of the angular contact rolling element comprising the inner raceways of the individual rows of rolling elements is made of two separate cold-formed fractional rings that are made out of a deep drawing steel and are positionally fixed on one side on a shoulder of the hub of the wheel side-fixing flange and clamped against each other on another side by a bent-over rim on said hub.

9. A wheel mounting of claim 3, wherein the inner bearing ring of the angular contact rolling bearing comprises a separate fractional ring on one side comprising the inner raceways of one pair of rows of rolling elements and the inner bearing ring is integrated on another side in the hub of the wheel side-fixing flange in that the inner raceways of the other pair of rows of rolling elements are configured directly in an outer side of said hub.

10. A wheel mounting of claim 9, wherein the separate fractional ring of the inner bearing ring is made out of one of a deep-drawing steel or a rolling bearing steel and is positionally fixed on one side on the hub of the wheel side-fixing flange against a shoulder arranged adjacent the inner raceways of the other pair of rows configured in the hub, and is clamped on another side against the shoulder by a bent-over rim on said hub.
